(19) United States
(12) Patent Application Publication
(10) Pub. No.: US 2002/0002988 A1
(43) Pub. Date: Jan. 10, 2002

(54) Method and apparatus for cleaning translucent tube for discharge lamp, and discharge lamp

(76) Inventors: Tsuyoshi Ichibakase, Osaka (JP); Makoto Horiuchi, Nara (JP); Makoto Kai, Osaka (JP); Tomoyuki Seki, Osaka (JP); Mamoru Takeda, Kyoto (JP); Shinichi Yamamoto, Osaka (JP); Kenichi Sasaki, Osaka (JP)

Correspondence Address: HARNESS, DICKEY & PIERCE, PLC, P.O. BOX 828, BLOOMFIELD HILLS, MI, 48303, US

(21) Appl. No.: 09/851,782

(22) Filed: May 9, 2001

(30) Foreign Application Priority Data
May 9, 2000 (JP) 2000-135544

(51) Int. Cl. B08B 3/00

(52) U.S. Cl. 134/22.12; 134/166 R

(57) ABSTRACT

A method for cleaning a translucent tube for a discharge lamp having a luminous bulb portion includes the steps of introducing a cleaning fluid from one end of the translucent tube; and allowing the cleaning fluid to flow while bringing the cleaning fluid in contact with at least an inner face of the luminous bulb portion of an inner face of the translucent tube, thereby removing impurities attached on the inner face of the luminous bulb portion.

### BACKGROUND OF THE INVENTION

The present invention relates to a method and an apparatus for cleaning a translucent tube for a discharge lamp. Furthermore, the present invention relates to a discharge lamp produced using a translucent tube that has been cleaned by such a cleaning method.

In recent years, an image projection apparatus such as a liquid crystal projector and a DMD projector has been widely used as a system for realizing large-scale screen images, and a high pressure discharge lamp having a high intensity (e.g., ultra high pressure mercury lamp and a metal halide lamp) has been commonly and widely used as the light source of such an image projection apparatus. Such a high pressure discharge lamp is produced by inserting an electrode assembly in which tungsten electrodes and metal foils are connected to each other into a glass tube for a discharge lamp (e.g., Japanese Laid-Open Patent Publication No. 10-321135).

FIG. 11 is a schematic cross-sectional view of a glass tube 100 for discharge lamp that is a translucent tube for a discharge lamp used to produce a high pressure discharge lamp. The glass tube 100 includes a substantially spherical luminous bulb portion 10 and a side tube portion 20 extending from the luminous bulb portion 10. The luminous bulb portion 10 is a portion that becomes the luminous bulb of the high pressure discharge lamp, and the side tube portion 20 is a portion that becomes the sealing portion (seal portion) of the high pressure discharge lamp. The glass tube 100 is formed of quartz glass from which alkaline components are removed as much as possible. The alkaline components are removed as much as possible for the following reasons. When an alkaline component (e.g., Na) is present in the glass tube 100 (in particular, the luminous bulb portion 10), the alkaline component becomes the seed of crystallization of the quartz glass, and crystallization of the quartz glass (phase transition to cristobalite) proceeds at a high temperature during lamp operation. As a result, the quartz glass becomes opaque. This phenomenon of becoming opaque is referred to as devitrification, and this is one factor that shortens the life of the discharge lamp. In order to suppress devitrification to prolong the life of the discharge lamp, the concentration of the alkaline components contained in the quartz glass constituting the glass tube for a discharge lamp is, for example, 1 ppm or less.

Since the glass tube 100 for a discharge lamp is handled with care so that impurities are not attached thereto, it conventionally has been believed that substantially no alkaline component is attached to the glass tube 100 supplied from, for example, a manufacturer. In measurement of the inventors of the present invention, the alkaline component attached to the glass tube 100 is in an undetectable level. Therefore, in the past, for example, when cleaning the glass tube 100, the glass tube 100 was immersed in a container 170 to which pure water 160 was constantly supplied to clean the glass tube 100, as shown in FIG. 12.

However, the observation of the inventors of the present invention confirmed that even if the glass tube 100 having an alkaline component concentration of 1 ppm or less is used to produce a discharge lamp, an influence of the alkaline component cannot be avoided. Although the inventors of the present invention handled the glass tube 100 under an inert atmosphere (e.g., argon) in order to prevent impurities from being mixed as much as possible in a production process of a discharge lamp, an influence of the alkaline component could not be eliminated. For this reason, when the glass tube 100 whose inner face was believed to have no alkaline component attached was tentatively cleaned and the impurity concentration of the alkaline component contained in the cleaning liquid was analyzed, the inventors of the present invention found that the alkaline component in a concentration of more than the alkaline component concentration in the quartz glass was attached on the inner face of the glass tube 100. In other words, it was found that the level of the alkaline component of the glass tube 100 was higher than the alkaline component level of the original material (quartz glass) because of attachment of the alkaline component on the glass tube 100.

In order to remove the alkaline component attached on the glass tube 100 to return the alkaline level to that of the original material (e.g., an alkaline component concentration of 1 ppm or less), it is not sufficient that the glass tube 100 is simply immersed in a flowing pure water, and a special cleaning is required. However, the glass tube 100 does not have a simple shape (e.g., not a disk shape as a semiconductor wafer), but has a complicated shape, so that it is difficult to clean the inner face of the glass tube 100, especially the inner face of the luminous bulb portion 10. This problem will be described further with reference to FIG. 13.

In the case where the glass tube 100 is immersed in a container 170 filled with pure water 160, generally an air bubble 32 is generated in the glass tube 100, as shown in FIG. 13. As shown in FIG. 12, the glass tube 100 lies in the container 170, an air bubble 32a is present in an upper portion of the internal portion of the luminous bulb portion 10 of the glass tube 100. This air bubble 32a remains in the upper portion of the internal portion of the luminous bulb portion 10 of the glass tube 100, even if the glass tube 100 is rotated or moved. Therefore, the air bubble 32a prevents the pure water 160 from being in contact with the inner face of the luminous bulb portion 10, so that the impurities present in the inner face of the luminous bulb portion 10 cannot be removed. Furthermore, also in the case of an air bubble 32b that is present in a portion other than the luminous bulb portion 10, as long as the air bubble 32b is present, the pure water 160 cannot be in contact with the inner face of the glass tube 100 in that portion, so that the impurities cannot be removed.

Furthermore, when a large air bubble 32c that blocks the internal portion of the glass tube 100 is present, the pure water 160 cannot flow in the internal portion of the glass tube 100, even if the pure water 160 continues to flow in the container 170. Therefore, the inner face of the glass tube 100 substantially cannot be cleaned. The reason is as follows. When the pure water 160 in the internal portion of the glass tube 100 stop flowing, even if the impurities present in the inner face of the glass tube 100 are dissolved in the pure water 160, the impurities cannot go out from the glass tube 100. Therefore, when glass tube 100 is dried after cleaning, the impurities are attached on the inner face of the glass tube 100 again. Therefore, unless the pure water 160 flows in the internal portion of the glass, the inner face cannot be cleaned, although the outer face of the glass tube 100 can be cleaned. In addition, even if there is no air bubbled 32 in the glass tube 100, the inner diameter of the glass tube 100 is not so large that the flow of the pure water 160 in the glass tube 100 is not satisfactory, or rather the pure water 160 hardly flows.

This is a problem not only in the case where the pure water 160 flows in the container 170, but this problem also occurs when cleaning the glass tube 100 immersed in the container 170 with ultrasonic waves. In other words, even if the impurities are ready to be dissolved in the pure water by applying ultrasonic waves, the impurities are eventually attached on the inner face of the glass tube 100 after drying, unless the impurities go out from the glass tube 100. Furthermore, a method of cleaning by inserting a rotating brush into the glass tube 100 causes scratches on the inner face of the glass tube 100, and therefore this is not practical.

### SUMMARY OF THE INVENTION

Therefore, with the foregoing in mind, it is a main object of the present invention to provide a method for cleaning away the impurities attached on the inner face of a translucent tube for a discharge lamp.

A method for cleaning a translucent tube for a discharge lamp having a luminous bulb portion includes the steps of introducing a cleaning fluid from one end of the translucent tube; and allowing the cleaning fluid to flow while bringing the cleaning fluid in contact with at least an inner face of the luminous bulb portion of an inner face of the translucent tube, thereby removing impurities attached on the inner face of the luminous bulb portion.

It is preferable that in the step of removing impurities, the cleaning fluid is allowed to flow while being in contact with an outer face of the translucent tube in the same step, thereby removing impurities attached on the outer face of the translucent tube.

It is preferable that the step of introducing a cleaning fluid includes the steps of disposing the translucent tube in a container for containing a cleaning liquid as the cleaning fluid such that ends of the tube are positioned in a substantially vertical direction; and injecting the cleaning liquid into the container. The step of removing impurities includes the steps of elevating a liquid surface of the cleaning liquid above an upper portion of the luminous bulb portion of the translucent tube for a discharge lamp; and lowering the liquid surface of the cleaning liquid below a lower portion of the luminous tube portion.

It is preferable that the step of elevating the liquid surface of the cleaning liquid and the step of lowering the liquid surface of the cleaning liquid are repeated.

It is preferable that the step of lowering the liquid surface of the cleaning liquid is performed such that the liquid surface of the cleaning liquid is lowered below a lower end of the translucent tube.

It is preferable that the step of elevating the liquid surface of the cleaning liquid is performed such that the liquid surface of the cleaning liquid is elevated above an upper end of the translucent tube.

It is preferable that the method further includes the step of discharging the cleaning liquid in the container from the container.

In one embodiment, the ending point of cleaning is determined by monitoring the concentration of the impurities contained in the cleaning liquid in the container.

It is preferable that the translucent tube is disposed using a holding tool for holding a plurality of translucent tubes such that ends of the tubes are positioned in a substantially vertical direction.

In one embodiment, the cleaning liquid is one selected from the group consisting of ultrapure water (the value of resistance: e.g., about 10MΩ or more), pure water (the value of resistance: e.g., about 1MΩ or more), deionized water (the value of resistance: e.g., about 1MΩ-10MΩ or more), hydrofluoric acid aqueous solution and hydrogen peroxide aqueous solution, and a combination of one of these cleaning liquids and cleaning fine particles.

In one embodiment, a plurality of kinds of impurities are attached on the inner face of the luminous bulb portion as the impurities, and the method includes at least a first step of introducing a first cleaning liquid as the cleaning liquid from the one end of the translucent tube with respect to a first kind of impurities of the plurality of kinds of impurities, and a second step of introducing a second cleaning liquid other than the first cleaning liquid as the cleaning liquid from the one end of the translucent tube with respect to a second kind of impurities other than the first kind of impurities of the plurality of kinds of impurities.

In one embodiment, the cleaning fluid is either one of gas, liquid, or fine particle powder, and the step of removing impurities attached on the inner face of the luminous bulb portion is performed by discharging the cleaning fluid introduced from one end of the translucent tube for a discharge lamp from the other end of the translucent tube for a discharge lamp.

In one embodiment, the cleaning fluid is inert gas (e.g., argon gas or nitrogen gas).

According to another aspect of the present invention, an apparatus for cleaning a translucent tube for a discharge lamp includes a container for accommodating a translucent tube for a discharge lamp having a luminous bulb portion and for containing a cleaning liquid; an injection pipe or an injection tube through which the cleaning liquid is injected into the container; a discharge pipe or a discharge tube through which the cleaning liquid in the container is discharged; and a concentration monitoring meter for monitoring a concentration of impurities that was attached on the translucent tube and is contained in the cleaning liquid in the container.

It is preferable that the concentration monitoring meter has a function to determine an end of cleaning by comparing an electrical conductivity of the cleaning liquid in the container or the cleaning liquid discharged from the container with a reference value, an electrical conductivity of the cleaning liquid injected to the injection pipe or the injection tube being used as the reference value.

In one embodiment, the container has an airtight structure that prevents the cleaning liquid in the container from being in contact with air outside the container.

According to another aspect of the present invention, a discharge lamp comprising a luminous bulb and sealing portions extending from the luminous bulb, the luminous bulb enclosing a luminous material and including a pair of electrodes opposed to each other therein, wherein the discharge lamp is produced by a method for producing a discharge lamp including the steps of preparing a translucent tube for a discharge lamp including a luminous bulb portion that becomes a luminous bulb of the discharge lamp, and side tube portions extending from the luminous bulb portion, the translucent tube having been subjected to a cleaning process; inserting an electrode assembly including metal foils and electrodes connected to the metal foils into the side tube portion such that the heads of the electrodes are positioned inside the luminous bulb portion; and forming the sealing portions by tightly attaching the metal foils of the electrode assembly to the side tube portions. The cleaning process includes the steps of (a) introducing a cleaning fluid from one end of a translucent tube for a discharge lamp including a luminous bulb portion that becomes a luminous bulb of the discharge lamp, and side tube portions extending from the luminous bulb portion; and (b) allowing the cleaning fluid to flow while bringing the cleaning fluid in contact with at least the inner face of the luminous bulb portion of the inner face of the translucent tube, thereby removing impurities attached on the inner face of the luminous bulb portion. The step (a) includes a step (a-1) of disposing the translucent tube in a container for containing a cleaning liquid as the cleaning fluid so that ends of the translucent tube are positioned in a substantially vertical direction; and a step (a-2) of injecting the cleaning liquid into the container. The step (b) includes a step (b-1) of elevating a liquid surface of the cleaning liquid above an upper portion of the luminous bulb portion of the translucent tube; and a step (b-2) of lowering the liquid surface of the cleaning liquid below a lower portion of the luminous tube portion.

In one embodiment of the discharge lamp, as the luminous material, at least mercury, a rare gas and halogen are enclosed in the luminous bulb, and the luminous bulb is made substantially of quartz glass, and the electrodes are made substantially of tungsten, and the mole number of the halogen is larger than the sum of the total mole number of metal elements that have the property of bonding to the halogen and are present in the luminous bulb (except for tungsten and mercury), and the mole number of the tungsten present in the luminous bulb after evaporated from the electrodes during lamp operation. In addition to that, when each kind of the metal elements (except for tungsten element and mercury element) is Mi, the mole number of the metal element Mi is mi, and the stoichiometric coefficient of the metal element Mi is ni, the mole number of the halogen is larger than the sum of the total number (Σ(mi×ni)) obtained by adding the numbers obtained by multiplying the mole number mi of the metal element Mi by the stoichiometric coefficient ni with respect to each kind of the metal elements Mi, and the mole number of the tungsten.

In one embodiment, the mole number of the halogen enclosed in the luminous bulb is not less than five times the total mole number of sodium (Na), potassium (K), lithium (Li), chromium (Cr), iron (Fe) and nickel (Ni) present in the luminous bulb.

In one embodiment, the discharge lamp is a mercury lamp in which a bulb wall load of the luminous bulb is 80 W/cm² or more.

According to the present invention, a cleaning fluid is introduced from one end of a translucent tube for a discharge lamp (e.g., glass tube or ceramic tube for a discharge lamp), and the cleaning fluid is allowed to flow while bringing the cleaning fluid in contact with at least the inner face of the luminous bulb portion. Thus, the impurities attached on the inner face of the luminous bulb portion can be removed satisfactorily by constantly introducing new cleaning fluid to the inner face of the luminous bulb portion.

Furthermore, when the cleaning fluid is allowed to flow while bringing the cleaning fluid in contact with, not only the inner face of the luminous bulb portion, but also the outer face of the translucent tube, the impurities attached on the outer face of the translucent tube as well as the impurities attached on the inner face thereof can be removed. As a result, the impurities (especially, fingerprints or oils and fats of workers) attached on the outer face of the translucent tube can be removed, so that the devitrification of the luminous bulb that may occur during lamp lighting due to the impurities can be prevented.

In the case where a cleaning liquid is used as the cleaning fluid, the cleaning liquid is allowed to flow while being in contact with the inner face of the luminous bulb portion in the following manner. A translucent tube is disposed in a container in which a cleaning liquid is to be poured so that the ends of the tube are positioned in a substantially vertical direction, and then the liquid surface of the cleaning liquid is elevated above the upper portion of the luminous bulb portion. Thereafter, the liquid surface of the cleaning liquid is lowered below the lower portion of the luminous bulb portion. In this case, it is preferable to repeat the process of elevating the liquid surface of the cleaning liquid and the process of lowering the liquid surface of the cleaning liquid. When the liquid surface of the cleaning liquid is lowered below the lower end of the translucent tube, the cleaning liquid having a high content of impurities can be discharged from the tube, so that the impurities attached on the inner face of the translucent tube can be removed satisfactorily. Also when the liquid surface of the cleaning liquid is elevated above the upper end of the translucent tube, the cleaning liquid having a high content of impurities can be discharged from the tube. Furthermore, this is also preferable, because the entire inner face of the translucent tube can be in contact with the cleaning liquid. It is more preferable to discharge the cleaning liquid in the container from the container, because the cleaning liquid containing impurities can be replaced by a cleaning liquid that has not been subjected to cleaning yet. Furthermore, when cleaning is performed while monitoring the concentration of the impurities contained in the cleaning liquid, it is possible to easily determine the time at which the impurities are removed completely (end of cleaning).

In the case where a holding tool for holding a plurality of translucent tubes for a discharge lamp is used, the plurality of translucent tubes can be cleaned, so that working efficiency can be improved. As the cleaning liquid, ultrapure water, pure water, deionized water, hydrofluoric acid aqueous solution, and hydrogen peroxide aqueous solution can be used, and a combination of one of these cleaning liquids and cleaning fine particles can be used. As the cleaning liquid, for example, ultrapure water is used, an alkaline component can be removed satisfactorily. In the case where a plurality of kinds of impurities are attached on the inner face of the luminous bulb portion, a first cleaning liquid is used with respect to a first kind of impurities, and a second cleaning liquid is used with respect to a second kind of impurities to clean the translucent tube.

Furthermore, as the cleaning fluid, either gas, liquid, or fine particle powder can be used to remove the impurities attached on the inner face of the luminous bulb portion by discharging the cleaning fluid introduced from one end of the translucent tube for a discharge lamp from the other end of the translucent tube for a discharge lamp. As the cleaning fluid, for example, inert gas such as argon gas and nitrogen gas can be used.

An apparatus for cleaning a translucent tube for a discharge lamp of the present invention includes an injection pipe (or injection tube) through which a cleaning liquid is injected into a container for accommodating the translucent tube for a discharge lamp, a discharge pipe (or discharge tube) through which the cleaning liquid is discharged from the container, and a concentration monitoring meter for monitoring the concentration of the impurities contained in the cleaning liquid in the container. Therefore, the impurity concentration can be monitored while cleaning, which can ensure the cleaning of the translucent tube for a discharge lamp. If the concentration monitoring meter has a function to determine the end of cleaning, the ending point of cleaning can be determined easily. In the case where the concentration monitoring meter is used, for example, the time at which the electrical conductivity of the cleaning liquid in the container or the cleaning liquid discharged from the container is substantially equal to a reference value can be set as the ending point of cleaning. Furthermore, in the case where the container has an airtight structure so that the cleaning liquid in the container is not in contact with the air outside the container, it is possible to prevent impurities contained in the air outside the container from being mixed with the cleaning liquid in the container.

In a discharge lamp produced with the translucent tube for a discharge lamp cleaned by the method for cleaning a translucent tube for a discharge lamp of the present invention, the impurities are removed satisfactorily, so that the discharge lamp has higher performance (e.g., longer lifetime) than those in the prior art.

According to the present invention, cleaning fluid is introduced from one end of a translucent tube for a discharge lamp (e.g., glass tube for a discharge lamp), and the cleaning fluid is allowed to flow while bringing the cleaning fluid in contact with at least the inner face of the luminous bulb portion. Therefore, the impurities attached on the inner face of the luminous bulb portion can be removed satisfactorily. As a result, the impurities (e.g., alkaline components) attached on the inner face of the luminous bulb portion can be cleaned away to the same concentration level as that of the impurities of the material (quartz glass) constituting the glass tube for a discharge lamp. Therefore, the present invention can produce a discharge lamp having a long lifetime in which devitrification or the like can be prevented.

This and other advantages of the present invention will become apparent to those skilled in the art upon reading and understanding the following detailed description with reference to the accompanying figures.

### BRIEF DESCRIPTION OF THE DRAWINGS

FIGS. 1A to 1C are cross-sectional views for illustrating a method for cleaning a translucent glass tube for a discharge lamp of an embodiment of the present invention.

FIGS. 2A and 2B are views for illustrating a method for cleaning a translucent tube for a discharge lamp of Embodiment 1.

FIG. 3 is a perspective view showing a structure of a cleaning apparatus 70.

FIG. 4 is a perspective view showing a structure of a holding tool 90.

FIG. 5 is a cross-sectional view showing a variation of the cleaning apparatus 70.

FIG. 6 is a flowchart showing each process of a cleaning method of Embodiment 2.

FIG. 7 is a flowchart showing the production process of a discharge lamp of Embodiment 3.

FIGS. 8A to 8C are cross-sectional views for illustrating a lamp production process S300.

FIG. 9 is a cross-sectional view schematically showing a structure of a discharge lamp 1000 of Embodiment 3.

FIG. 10 is a cross-sectional view schematically showing a structure of a lamp provided with a mirror 1200.

FIG. 11 is a cross-sectional view of a glass tube for a discharge lamp.

FIG. 12 is a view for illustrating a method for cleaning a glass tube for a discharge lamp.

FIG. 13 is a view for illustrating a problem of a method for cleaning a glass tube for a discharge lamp.

### DETAILED DESCRIPTION OF THE INVENTION

Hereinafter, embodiments of the present invention will be described with reference to the accompanying drawings. In the following drawings, for simplification, elements having substantially the same functions have the same reference numerals.

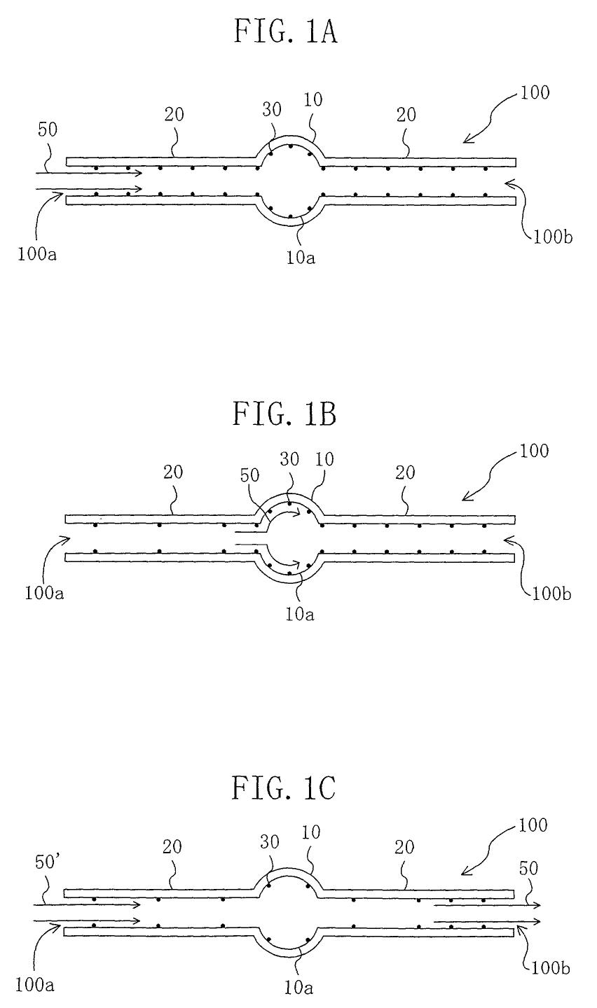

FIGS. 1A to 1C are cross-sectional views schematically showing each process of a method for cleaning a translucent tube for a discharge lamp of en embodiment of the present invention.

First, a glass tube 100 for a discharge lamp that is a translucent tube for a discharge lamp having a substantially spherical luminous bulb portion 10 and side tube portions 20 is prepared. The inner diameter and the glass thickness of the luminous bulb portion 10 of the glass tube 100 prepared in this embodiment are 6 mm and 3 mm, respectively. The inner diameter and the length in the longitudinal direction of the side tube portion 20 is 3.4 mm and 250 mm, respectively. The glass tube 100 is formed of quartz glass, for example, having an alkaline component concentration of 1 to 2 ppm, preferably 1 ppm or less. Impurities 30 are attached on the inner face (e.g., inner face 10a of the luminous bulb portion 10) of the prepared glass tube 100 before cleaning. Examples of the impurities 30 include alkaline components (Na, K etc.), silica powder, and organic substances. In this embodiment, a glass tube for a discharge lamp is used, but the glass tube for a discharge lamp can be replaced by a ceramic tube for a discharge lamp.

As shown in FIG. 1A, cleaning fluid 50 is introduced from one end 100a of the glass tube 100. The introduced cleaning fluid 50 flows while being in contact with the inner face 10a of the luminous bulb portion 10, as shown in FIG. 1B, and impurities 30 attached at least on the inner face 10a of the luminous bulb portion 10 are removed, as shown in FIG. 1C. Then, the cleaning fluid 50 is discharged from the other end 100b of the glass tube 100, and thereafter new cleaning fluid 50′ is introduced from the one end 100a of the glass tube 100, and the impurities 30 are removed by the cleaning fluid 50′. This introduction of cleaning fluid is repeated, and at the point where all the attached impurities 30 are removed, the glass tube 100 has been cleaned to the same concentration level as that of the impurities contained in the material (quartz glass) constituting the glass tube 100.

According to the cleaning method of this embodiment, the cleaning fluid 50 flows while being in contact with the inner face 10a, so that the cleaning fluid 50 washes away the impurities 30. Furthermore, it is possible to remove the impurities 30 in an infinite dilution manner by replacing the cleaning fluid 50 in the glass tube 100 by new cleaning fluid. On the other hand, in the cleaning method shown in FIG. 12, even if the glass tube 100 is moved more or less, the pure water in the glass tube 100 is hardly moved, and the pure water in the glass tube 100 can hardly be replaced. For this reason, in the cleaning method shown in FIG. 12, removal of impurities is performed by diffusing the impurities in substantially stationary pure water. Therefore, the cleaning method of this embodiment can remove the impurities 30 from the tube more satisfactorily.

As the cleaning fluid 50 in this embodiment, either gas (argon gas), liquid (cleaning liquid) or fine particle powder (quartz beads) can be used. The cleaning fluid introduced from one end 100a of the glass tube 100 is discharged only from the other end 100b, as shown in FIG. 1C, but also from the one end 100a when the cleaning fluid is, for example, a cleaning liquid.

Hereinafter, an embodiment will be described in the case where a cleaning liquid is used as the cleaning fluid, and a glass tube for a discharge lamp is used as the translucent tube for a discharge lamp. However, the present invention is not limited by the following embodiments. For example, a ceramic tube for a discharge lamp can replace the glass tube for a discharge lamps

Embodiment 1

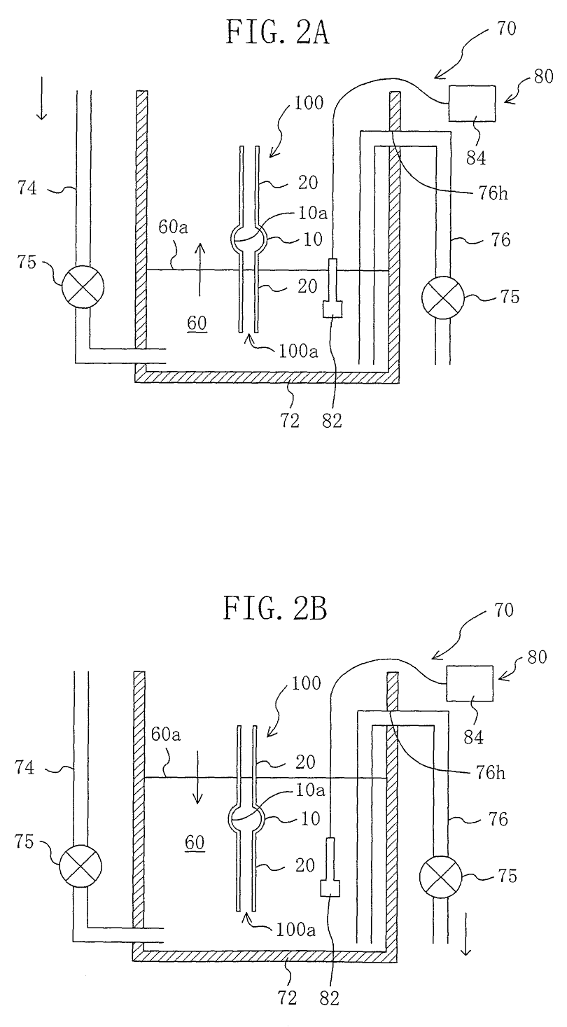

A method for cleaning a glass tube for a discharge lamp with a cleaning liquid as the cleaning fluid will be described with reference to FIGS. 2A and 2B. FIGS. 2A and 2B schematically show each process of a cleaning method of Embodiment 1.

First, as shown in FIG. 2A, a glass tube 100 for a discharge lamp is disposed in a container 72 of a cleaning apparatus 70 provided with the container 72 for containing a cleaning liquid 60. The glass tube 100 is disposed so that the ends of the glass tube 100 are in a substantially vertical direction. One end 100a of the glass tube 100 is positioned in a lower portion of the container 72.

Next, the cleaning liquid 60 is injected into the container 72 through an injection pipe (or injection tube) 74 for injection of the cleaning liquid 60 into the container 72. The amount of the cleaning liquid 60 to be injected can be adjusted by a valve 75. As the cleaning liquid 60 is injected into the container 72, the liquid surface 60a of the cleaning liquid 60 is elevated. Therefore, after the cleaning liquid 60 is introduced from one end 100a of the glass tube 100, the cleaning liquid 60 in the glass tube 100 flows upward while being in contact with the inner face of the glass tube 100. The injection of the cleaning liquid 60 continues and the cleaning liquid 60 in the glass tube 100 is allowed to flow while being in contact with the inner face 10a of the luminous bulb portion 10, so that the impurities (not shown) attached on the inner face 10a of the luminous bulb portion 10 are removed.

In this case, the cleaning liquid 60 flows upward while in contact with not only the inner face of the glass tube 100, but also the outer face of the glass tube 100. Therefore, not only the impurities attached on the inner face 10a of the luminous bulb portion 10, but also the impurities attached on the outer face (especially, outer face of the luminous bulb portion 10) of the glass tube 100 are removed. In the outer face of the glass tube 100, finger prints or oils and fats of workers containing much of impurities such as sodium are readily attached. It is not preferable that they remain on the luminous bulb of a discharge lamp, because this may cause devitrification. More specifically, since the temperature is increased not only in the inner face of the luminous bulb, but also the outer face during lamp lighting, and therefore finger prints or oils and fats are burned and attached thereto, which may cause devitrification. In this embodiment, the outer face of the glass tube 100 as well as the inner face thereof can be cleaned, so that such devitrification can be prevented effectively. In addition, the inner face and the outer face of the glass tube 100 can be cleaned at the same time, so that working efficiency is good.

At the point where the liquid surface 60a of the cleaning liquid 60 is elevated above the upper portion of the luminous bulb portion 10, the entire inner face 10a of the luminous bulb portion 10 has been cleaned with the cleaning liquid 60. Thereafter, the injection of the cleaning liquid 60 from the injection pipe 74 continues so that the liquid surface 60a of the cleaning liquid 60 is elevated until the liquid surface reaches a predetermined height in the container 72, preferably, above the upper end of the glass tube 100. When the liquid surface 60a is elevated above the upper end of the glass tube 100, the cleaning liquid 60 can be in contact with the entire inner face of the glass tube 100. In addition, the cleaning liquid 60 can be replaced by discharging the cleaning liquid 60 in the tube from the upper end of the glass tube 100. Furthermore, for example, when dust is present on the liquid surface 60a, it is possible to prevent the dust from being attached and remaining on the inner face of the tube.

Next, as shown in FIG. 2B, the cleaning liquid 60 in the container 72 is discharged through a discharge pipe (discharge tube) 76 for discharge of the cleaning liquid 60 in the container 72 to lower the liquid surface 60a of the cleaning liquid 60. In this embodiment, the cleaning liquid 60 is injected into the container 72 through the injection pipe 74 in the state where both the valve 75 of the injection pipe 74 and the valve 75 of the discharge pipe 76 are open, so that the liquid surface 60a of the cleaning liquid 60 is elevated to the height of the uppermost portion 76h of the discharge pipe 76. When the liquid surface 60a reaches the uppermost portion 76h, the cleaning liquid is discharged (drained) automatically on the principle of siphon. When the inner diameter of the discharge pipe 76 is larger than that of the injection pipe 74, the discharge liquid 60 can be completed without stopping the injection of the cleaning liquid 60. Thus, the up and down of the liquid surface 60a can be repeated infinitely. Furthermore, the up and down of the liquid surface 60a can be performed by adjusting the valve 75 of the injection pipe 74 and the valve 75 of the discharge pipe 76. Alternatively, the discharge pipe (liquid removing pipe) is provided in a lower portion of the container 72 or on the bottom face of the container 72, so that the cleaning liquid 60 can be discharged from the discharge pipe. In this case, after the injection of the cleaning liquid 60 is stopped, the cleaning liquid 60 is discharged.

When the liquid surface of the cleaning liquid 60 is lowered below the lower portion of the luminous bulb portion 10 by the discharge of the cleaning liquid 60, the cleaning liquid 60 moves while being in contact with the inner face 10a of the luminous bulb portion 10. In this embodiment, the cleaning liquid 60 in the tube is removed by lowering the liquid surface 60a below the lower end 100a of the glass tube 100, and the liquid surface 60a is elevated again by new cleaning liquid 60 that is constantly injected from the injection pipe 74. Thus, cleaning can be performed while replacing the entire cleaning liquid 60 in the glass tube 100.

After the liquid surface 60a of the cleaning liquid 60 is lowered below the lower portion of the luminous bulb portion 10, the liquid surface 60a can be elevated again. In this case, the inner face of the glass tube 100 can be cleaned while replacing a part of the cleaning liquid 60 in the glass tube 100 by a part of the cleaning liquid 60 outside the tube. Furthermore, it is possible to combine the method of partially replacing the cleaning liquid 60 in the tube and the method of entirely replacing the cleaning liquid 60 in the tube. In this embodiment, the liquid surface 60a is elevated and lowered by the injection and the discharge of the cleaning liquid 60. However, the liquid surface 60a can be elevated and lowered by physically moving the glass tube 100 up and down (e.g., mechanically or manually).

The glass tube 100 is cleaned by repeating elevating and lowering the liquid surface 60a a plurality of times. In this embodiment, for example, a set of elevating and lowering the liquid surface 60a is performed over about 5 minutes, and cleaning is carried out by performing the total of five sets.

When it is desired to clean the glass tube 100 sufficiently within a necessity minimum time while confirming that cleaning is completed, the end of cleaning can be determined by monitoring the concentration of the impurities contained in the cleaning liquid 60 in the container 72. For example, cleaning can be performed while monitoring with a concentration monitoring meter whether or not the concentration of the impurities in the cleaning liquid 60 to be injected to the injection pipe 74 and the concentration of the impurities in the cleaning liquid 60 in the container 72 are within a predetermined range (or substantially equal). The concentration of the impurities in the cleaning liquid 60 discharged from the container 72 can be monitored instead of the concentration of the impurities of the cleaning liquid 60 in the container 72.

The concentration of the impurities contained in the cleaning liquid 60 can be measured, for example, with an electrical conductivity meter. More specifically, as shown in FIGS. 2A and 2B, using an electrical conductivity meter 82 for measuring the electrical conductivity of the cleaning liquid 60 in the container 72 and a concentration monitoring meter 80 provided with a monitor 84 showing the indicated value of the electrical conductivity meter 82, the end of cleaning can be determined. First, before disposing the glass tube 100 in the container 72, the cleaning liquid (e.g., pure water or ultrapure water) 60 to be injected to the injection pipe 74 is poured, for example, in the container 72, and the electrical conductivity of the cleaning liquid 60 is measured with the electrical conductivity meter 82, and the indicated value obtained by the measurement is used as the reference value. Thereafter, when cleaning the glass tube 100, the electrical conductivity of the cleaning liquid 60 in the container 72 is compared with the reference value, so that the end of cleaning can be determined. Furthermore, the electrical conductivity meter is placed in a cleaning liquid supply tank (not shown) of the cleaning liquid 60 to be injected to the injection pipe, and the indicated value from the electrical conductivity meter can be used as the reference value.

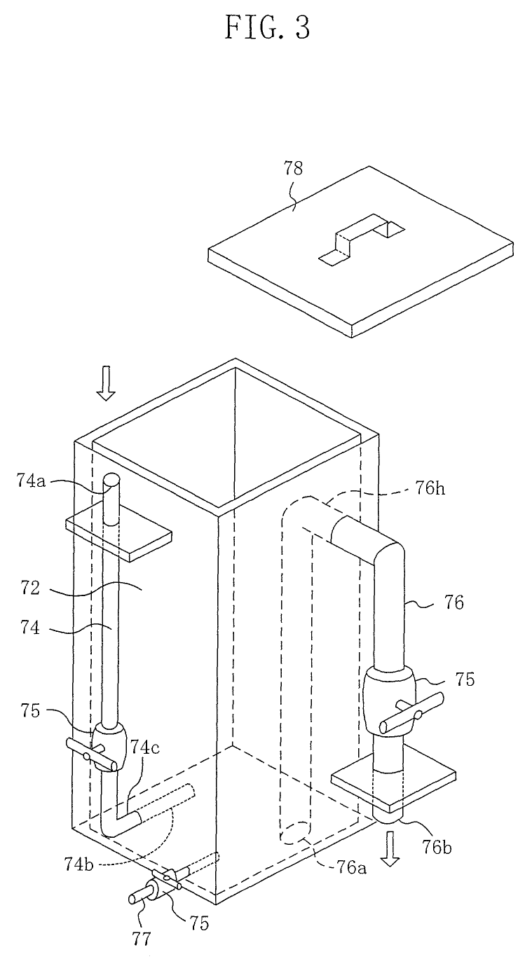

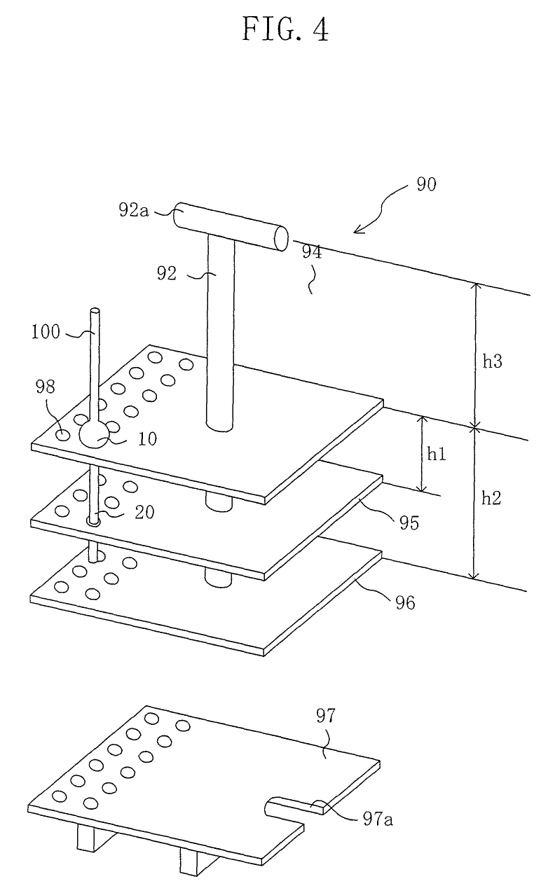

Next, an apparatus and a tool suitably used in the cleaning method of Embodiment 1 will be described with reference to FIGS. 3 and 4. FIG. 3 is a perspective view showing the structure ofe the cleaning apparatus 70 shown in FIG. 2. FIG. 4 is a perspective view of a holding tool 90 for holding a plurality of glass tubes 100 for a discharge lamp positioned substantially in the vertical direction.

The cleaning apparatus 70 shown in FIG. 3 includes a container 72 for containing a cleaning liquid 60 into the container 72, an injection pipe 74 through which the cleaning liquid 60 is injected, and a discharge pipe 76 through which the cleaning liquid 60 in the container 72 is discharged. The cleaning apparatus 70 further includes a concentration monitoring meter 80 (see FIG. 2) for monitoring the concentration of the impurities contained in the cleaning liquid 60 in the container 72 (impurities attached on the glass tube 100), which is not shown in FIG. 3. The container 72, the injection pipe (or injection tube) 74, and the discharge pipe (or discharge tube) 76 of the cleaning apparatus 70 are made of polyvinylchloride (thickness: for example, about 5 mm) so as to prevent impurities of the materials constituting these members from being mixed with the cleaning liquid 60. Instead of polyvinylchloride, PTFE (e.g., Teflon (registered trademark)) can be used.

The upper face of the container 72 is open, and glass tube 100 is inserted from the opening on the upper face so that glass tube 100 can be disposed in the container 72. After disposing the glass tube 100 in the container 72, it is desired to set a lid 78 on the upper face of the container 72 so as to shut off dust or the like from the container 72. The upper face and the lower face of the container 72 are squares having a side of about 310 mm, and the height of the container 72 is, for example, about 505 mm. The shape of the container 72 may be a rectangle having rectangular top and bottom faces, or may be a cylinder having circular top and bottom faces.

The injection pipe 74 has one end 74a from which the cleaning liquid (e.g., pure water) 60 is introduced, and the other end 74b from which the cleaning liquid 60 is supplied to the container 72. The one end 74a is positioned outside the container 72, and the other end 74b is positioned in the container 72. When injecting the cleaning liquid 60, for example, a hose made of polyvinylchloride can be connected to the one end 74a. In this embodiment, the injection pipe 74 penetrates the side of the container 72 at a predetermined portion 74c, and a valve 75 for adjusting the amount of the cleaning liquid 60 to be injected is provided between the one end 74a and the other end 74b of the injection pipe 74.

The discharge pipe 76 has one end 76a positioned in the container 72 and the other end 76b positioned outside the container 72. The one end 76a of the discharge pipe 76 is provided in a lower portion of the container 72, preferably in a portion lower than the lower end of the glass tube 100 disposed in the container 72. When the one end 76a of the discharge pipe 76 is provided in a portion lower than the lower end of the disposed glass tube 100, the following advantage is provided. When the cleaning liquid 60 is discharged, the liquid surface 60a of the cleaning liquid 60 can be lowered below the lower end of the glass tube 100. As a result, the entire cleaning liquid 60 in the tube can be let out from the glass tube 100. Furthermore, it is preferable to provide the uppermost portion 76h of the discharge pipe 76 in a portion higher than the upper portion of the luminous bulb portion 10 of the disposed glass tube 100, when discharging the cleaning liquid 60 from the discharge pipe 76 using the principle of siphon. It is more preferable to provide the uppermost portion 76h in a portion higher than the upper end of the disposed glass tube 100. Since the valve 75 is provided in the discharge pipe 76, discharge can be adjusted and controller by the valve 75. In this embodiment, apart from the discharge pipe, a pipe 77 for liquid removal provided with a valve 75 for the purpose of removing the cleaning liquid 60 is provided in a lower portion of the side of the container 72. Therefore, the cleaning method of this embodiment can be performed by using the pipe 77 for liquid removal as the discharge pipe without using the discharge pipe 76.

Next, a holding tool 90 for holding a plurality of glass tubes 100 for discharge lamps will be described. The holding tool 90 of FIG. 4 includes a holding plate 94 having openings 98 through which the side tube portions 20 of the glass tube 100 pass and the luminous bulb portions 10 do not pass, and a supporting rod 92 for supporting the holding plate 94. The holding plate 94 is attached to the supporting rod 92 that the holding plate 94 is substantially horizontal, so that the glass tubes 100 can be positioned in the substantially vertical direction by inserting the glass tubes 100 into the openings 98 of the holding plate 94. About one hundred openings 98 are provided in the holding plate 94, and therefore, using the holding tool 90, about one hundred glass tubes 100 can be cleaned at one time.

Below the holding plate (upper plate) 94, there are a middle plate 95 that prevents the side tube portions 20 of the glass tubes 100 from moving freely, and a lower plate 96 that is provided under the middle plate 95 and is to be disposed on a stand 97. In addition to the holding plate (upper plate) 94, the middle plate 95 and the lower plate 96 are also supported by the supporting rod 92, and when the glass tubes 100 are set into the holding tool 90, the lower ends of the glass tubes 100 are positioned between the middle plate 95 and the lower plate 96. It is not necessary that the lower plate 96 and the stand 97 are provided with openings through which the glass tubes pass, but it is desired that the lower plate 96 and the stand 97 are provided with the openings 98 so that the cleaning liquid 60 can be let in and out satisfactorily. Furthermore, this is preferable, because the same member as those of the upper plate 94 and the middle plate 95 can be used to produce the tool.

A handle 92a used to lift the holding tool 90 is formed in an upper portion of the supporting rod 92, and the holding tool 90 can be disposed in the container 72 of the cleaning apparatus 70 with the handle 92a. Therefore, after a plurality of glass tubes 100 are set in the holding portion 90, the stand 97 is disposed on the bottom face of the container 72, and then the holding tool 90 is moved into the container 72 with the handle 92a, so that each of the plurality of glass tubes 100 can be disposed in the container 72, each positioned in a substantially vertical direction. When the cleaning liquid 60 is poured in the container 72, the holding tool 90 is stabilized in the container 72 by its self-weight, and thus the glass tubes 100 can be positioned stably in the container by the holding tool 90.

The stand 97 supporting the holding tool 90 is larger that the lower plate 96 of the holding tool 90, and a notch 97a is provided in the stand 97 so that a portion in the vicinity of the one end 76a of the discharge pipe 76 is not overlapped with the stand 97, when the stand 97 is disposed on the bottom face of the container 72. When disposing the holding tool 90 on the stand 97, it is preferable that an opening provided in the lower plate 96 of the holding tool 90 is matched with the opening provided in the stand 97, because the cleaning liquid 60 can be let in and out satisfactorily.

The members (e.g., the holding plate 94 and the supporting rod 92) constituting the holding tool 90 are formed of, for example, polyvinylchloride so as to prevent impurities from being mixed in the cleaning liquid 60. In this embodiment, a gap hi between the upper plate 94 and the middle plate 95 is for example, about 100 mm. A gap h₂ between the upper plate 94 and the lower plate 96 is for example, about 165 mm, and a gap h₃ between the upper plate 94 and the handle 92a is for example, about 200 mm. After the plurality of tubes 100 are set in the holding tool 90, the holding tool 90 is disposed in the container 72. Then, elevating and lowering the liquid surface 60a is repeated a plurality of times, and thus the plurality of glass tubes 100 can be cleaned. The end of cleaning can be determined with the concentration monitoring meter 80.

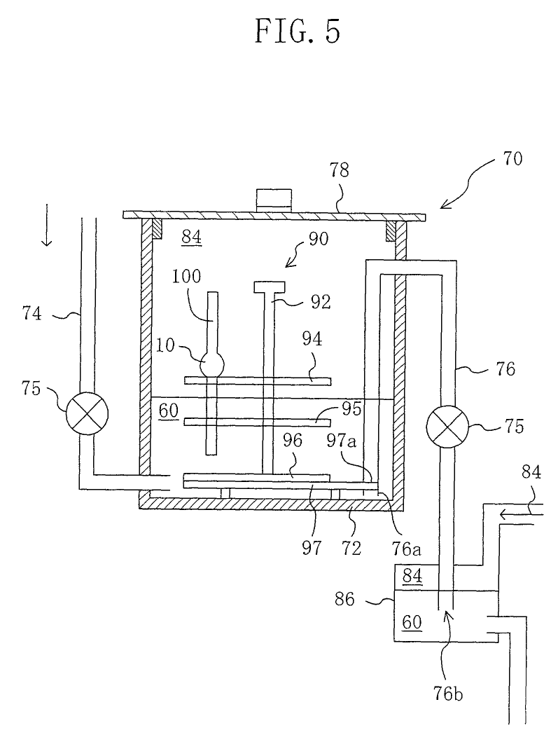

In order to prevent impurities (e.g., alkaline components) contained in the ambient air surrounding the cleaning apparatus 70 from entering the container 72, as shown in FIG. 5, the container 72 can be of an airtight structure. More specifically, after the holding tool 90 in which glass tubes 100 are set is disposed in the container 72, an inert gas (e.g., Ar) 84 is filled in the container 72, and then a lid 78 is attached so that the opening on the top face of the container 72 is sealed. Also in order to prevent the ambient air from entering the container from the discharge pipe 76, a discharged liquid receptacle 86 is provided in an outlet (the other end) 76b of the discharge pipe 76 and an inert gas 84 is filled in the discharged liquid receptacle 86. Alkaline components are contained in the air in some concentration, and the concentration is larger in seaside areas. Therefore, it is preferable to use the container 72 of an airtight structure to clean the glass tubes 100 in order to obtain the glass tubes 100 whose impurities level is maintained at the level of the original material (quartz glass).

Embodiment 2

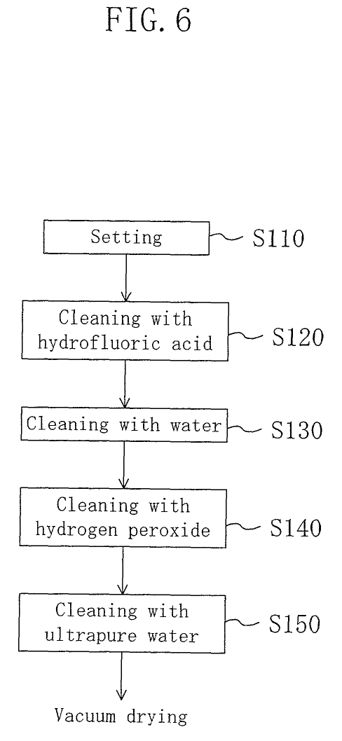

In Embodiment 1, a method for cleaning a glass tube for a discharge using one kind of cleaning liquid (e.g., pure water) has been described, but the present invention can apply to a method for cleaning a glass tube for a discharge lamp to remove a plurality of kinds of impurities with a plurality kinds of cleaning liquid. Hereinafter, a cleaning method of Embodiment 2 will be described with reference to FIG. 6. The same description as in Embodiment 1 will be omitted or simplified.

FIG. 6 is a flowchart showing each step of the cleaning method of this embodiment. First, a glass tube 100 for a discharge lamp is set in the holding tool 90 shown in FIG. 4 (step S110), and the holding tool 90 in which the glass tube 100 is set is disposed in a container 72 of a first cleaning apparatus 70 (see FIG. 3). A hydrofluoric acid aqueous solution is supplied as the cleaning liquid 60 to the container 72 of the first cleaning apparatus 70, and the liquid surface 60a (liquid surface of hydrofluoric acid aqueous solution) in the container 72 of the first cleaning

After cleaning at step S150, in order to protect the glass tube 100 from contamination by impurities contained in the ambient air surrounding the glass tube 100, argon gas is introduced from one end of the glass tube 100, and allowed to flow while being in contact with the inner face of the glass tube 100. Then, argon gas is discharged from the other end of the glass tube 100. Such flow of argon allows the air in the glass tube 100 to be purged by the argon gas, so that the cleaned state after step S150 can be maintained.

Furthermore, when the air in the glass tube 100 is purged by argon, even if the glass tube 100 is moved, argon stays in the glass tube 100, and argon in the glass tube 100 is not replaced by the ambient air for a comparatively long time (e.g., about several ten minutes to several hours). Therefore, the purge of the air in the glass tube 100 by argon is also advantageous in that handling of the glass tube 100 becomes easy. In addition to purging the air in the glass tube 100 by argon, fine powder particles (e.g., quartz beads) can be introduced from one end of the glass tube 100, and the fine powder particles are brought in contact with the inner face of the glass tube 100, so that impurities or dust attached on the inner face of glass tube 100 (especially inner face 10a of the luminous bulb portion 10) can be removed.

Embodiment 3

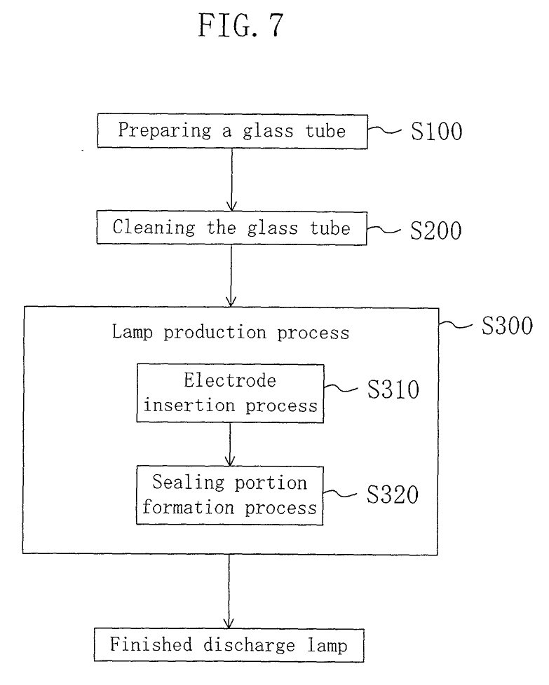

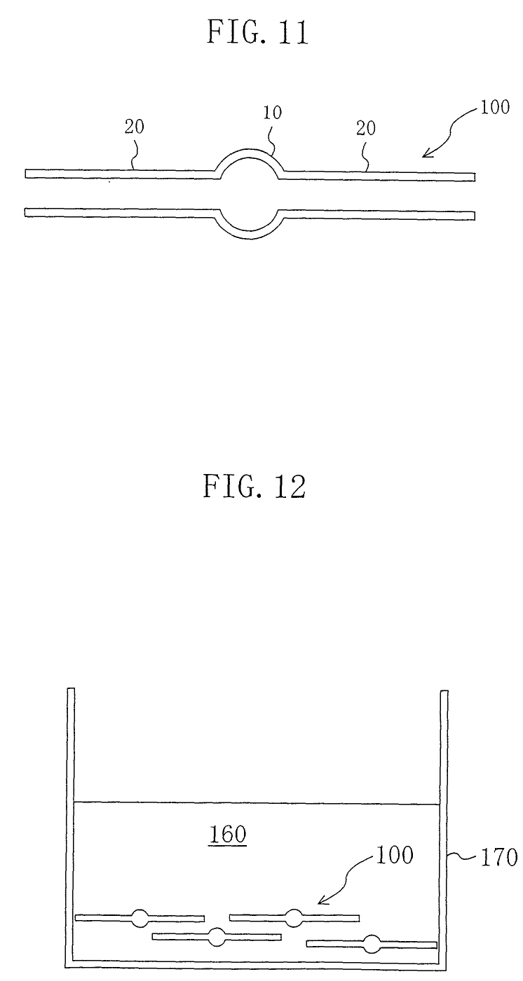

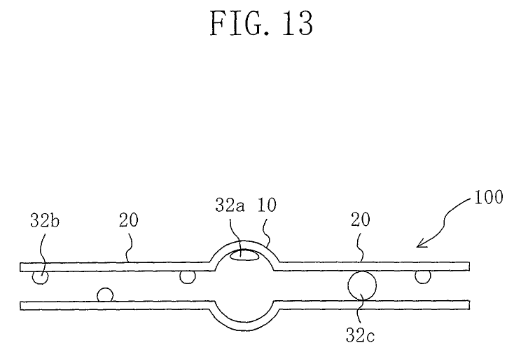

The translucent tube for a discharge lamp that has been cleaned by the cleaning method of the above described methods is used to produce a discharge lamp. Hereinafter, a discharge lamp produced with the translucent tube for a discharge lamp that has been cleaned by the cleaning method of the above described methods will be described with reference to FIGS. 7 to 11. The same description as in the above embodiments will be omitted or simplified.

FIG. 7 is a flowchart showing a production process of a discharge lamp of this embodiment.

First, a quartz glass tube for a discharge lamp is prepared as a translucent tube for a discharge lamp (step S100). The glass tube prepared in this embodiment is the same as that of Embodiment 1 (see FIGS. 1, 2A and 2B or the like). In this embodiment, a glass tube for a discharge lamp is used, but a ceramic tube for a discharge can replace the glass tube for a discharge lamp.

Next, the glass tube is cleaned in the manner as described in the above embodiments (step S200). This step provides a glass tube that has been cleaned to the level of the impurities contained in the material (quartz glass) constituting the glass tube.

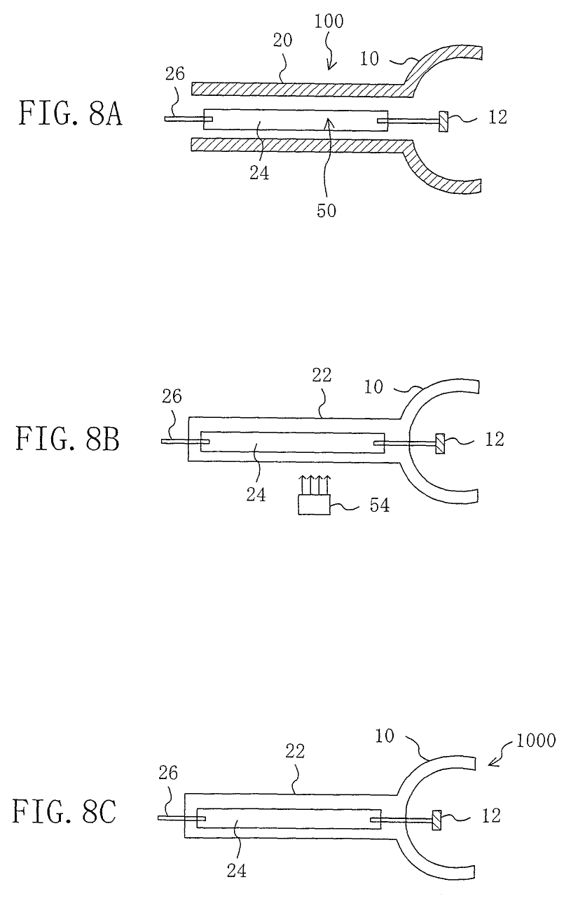

Then, using the cleaned glass tube, a known lamp production process (step S300) is performed, so that a discharge lamp is completed. The lamp production process primarily includes an electrode insertion process (step S310) and a sealing portion formation process (step S320). These processes will be described briefly with reference to FIGS. 8A and 8C.

First, as shown in FIG. 8A, an electrode assembly 50 including a metal foil (Mo foil) 24 and an electrode 12 connected to the metal foil 24 is inserted into the side tube portion 20 of the cleaned glass tube 100 (step S310). In this process, the electrode assembly 50 is inserted so that the head of the electrode 12 is positioned inside the luminous bulb portion 10 and the metal foil 24 is positioned inside the side tube portion 20. A coil is wound around the head of the electrode 12, and the coil has a function to reduce the temperature at the electrode head during lamp operation. An external lead 26 is connected to the metal foil 24 of the electrode assembly 50 on the side opposite to the side connected to the electrode 12.

Next, as shown in FIG. 8B, the pressure in the glass tube 100 is reduced (e.g., less than one atmospheric pressure), and the side tube portion 20 of the glass tube 100 is heated and melted with a burner 54, so that the side tube portion 20 and the metal foil 24 are attached so that the sealing portion 22 is formed (sealing portion formation process S320). Thereafter, a rare gas, halogen and mercury are enclosed in the luminous bulb portion 10, and then the other side tube portion 20 is subjected to the electrode insertion process S310 and the sealing portion formation process S320, and a pair of sealing portions 22 seals the luminous bulb 10. Then, as shown in FIG. 8C, a discharge lamp 1000 can be obtained. In the thus produced discharge lamp 1000, the impurities are removed more satisfactorily than an uncleaned glass tube or a glass tube cleaned by the cleaning method shown in FIG. 12, so that the discharge lamp of this embodiment can exhibit more excellent characteristics (e.g., longer lifetime) than those of conventional lamps

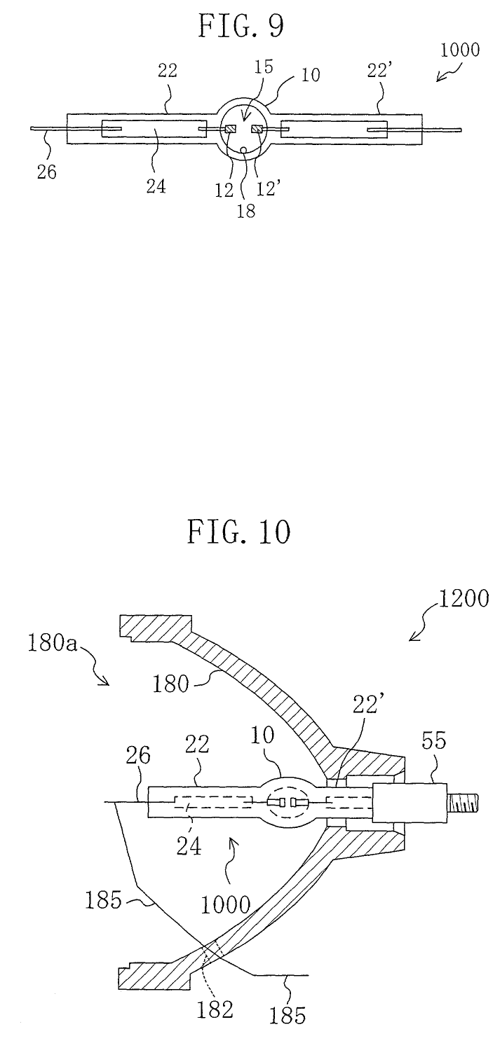

FIG. 9 shows the structure of the discharge lamp 1000 of this embodiment. The discharge lamp shown in FIG. 9 is a mercury lamp (e.g., high pressure mercury or ultra high pressure mercury lamp), and includes a luminous bulb 10 made substantially of quartz glass and a pair of electrodes 12 and 12′ disposed in a space (discharge space) 15 in the luminous bulb 10 and made substantially of tungsten. In the discharge space 15 of the luminous bulb 10, at least mercury 18, and a rare gas and halogen are enclosed. The main purposes for this enclosure are as follows. The mercury 18 is enclosed as a luminous material, and the rare gas is enclosed as a gas for smooth start, and halogen is enclosed to activate the halogen cycle.

In this embodiment, the mole number of halogen enclosed in the luminous bulb 10 is larger than the sum of the total mole number of metal elements that have the property of bonding to halogen (except for tungsten and mercury) and are present in the luminous bulb 10, and the mole number of tungsten that is evaporated from the electrodes 12 and 12′ during lamp operation and is present in the luminous bulb 10. Typical examples of metal elements having the property of bonding to halogen are alkali metal elements (Na, K, etc.), when excluding tungsten element and mercury element. The reason that the mole number of halogen is defined as above is described in detail in International Application No PCT/JP00/04561 (International filing date Jul., 6, 2000, Applicant: Matsushita Electric Industrial Co. Ltd.), which is incorporated herein by reference.

The reason that the mole number of halogen is defined will be described briefly. When the mole number of halogen is defined as above, halogen that can contribute to the halogen cycle can be constantly present in the luminous bulb 10, so that the activation of the halogen cycle can be ensured. Thus, blackening occurring in the luminous bulb 10 can be prevented. This prevention of blackening prolongs the life of the lamp (e.g., 5000 hours to 10000 hours or more), even if the lamp is used under high output conditions (the bulb wall load of the luminous bulb is for example, 80 W/cm² or more) that may end the lamp life early in the prior art. The following is a possible reason why the mole number of halogen was not defined in the prior art. The mechanism of blackening was not examined based on the phenomenon of actual lamp operations under high output conditions. In addition, as described above, it was conventionally believed that alkaline components were hardly attached on the glass tube 100 for a discharge lamp that was handled with care so as not to attach impurities.

In the discharge lamp of this embodiment, impurities present in the inner face of the luminous bulb are removed satisfactorily by the cleaning method of the above embodiments. Therefore, with the amount level of enclosed halogen that does not interfere with lamp operation, it can be easily realized that the mole number of halogen is larger than the sum of the total mole number of the above-described metal elements and the mole number of evaporated tungsten. On the other hand, in the case of a discharge lamp produced with a uncleaned glass tube or a glass tube that has been cleaned by the cleaning method shown in FIG. 12, there are a large amount of impurities that have not been removed in the luminous bulb 10, so that it is virtually difficult that the amount level of enclosed halogen that does not interfere with lamp operation satisfies the halogen mole number condition defined as above, which was experimentally confirmed by the inventors of the present invention.

In view of the case where one metal atom can be bonded to a plurality of halogens, a preferable mole number of halogen to be enclosed is as follows. When each kind of metal elements (except for tungsten element and mercury element) having the property of bonding to halogen is Mi, the mole number of halogen of a metal element Mi is mi, and the stoichiometric coefficient of the metal element Mi is ni, it is preferable that the mole number of halogen is larger than the sum of the total number (Σ(mi×ni)) obtained by adding the numbers obtained by multiplying the mole number mi of the metal element Mi by the stoichiometric coefficient ni with respect to each kind of the metal elements Mi, and the mole molybdenum is electrically connected to one end of the metal foil 24. The rated power is 150 W (corresponding to a bulb wall load of about 85 W/cm²).

The discharge lamp 1000 of Embodiment 3 can be formed into a lamp 1200 provided with a reflecting mirror in combination with a reflecting mirror 180, as shown in FIG. 10. If the lamp 1200 provided with a reflecting mirror is combined with a housing (not shown) for supporting the lamp, a lamp unit can be formed. FIG. 10 schematically shows a cross-section of the lamp 1200 provided with a reflecting mirror.

The lamp 1200 provided with a reflecting mirror includes the discharge lamp 1000 including a substantially spherical luminous portion 10 and a pair of sealing portions 22, and a reflecting mirror 180 for reflecting light emitted from the discharge lamp 1000.

The reflecting mirror 180 is designed to reflect the radiated light from the discharge lamp 1000 so that the light becomes, for example, a parallel luminous flux, a condensed luminous flux converged on a predetermined small area, or a divergent luminous flux equal to that emitted from a predetermined small area. As the reflecting mirror 180, a parabolic reflector or an ellipsoidal mirror can be used, for example. In the example shown in FIG. 10, a lamp base 55 is attached to one of the sealing portion 22′ of the discharge lamp 1000, and an external lead 26 extending from the sealing portion 22 and the lamp base 55 are electrically connected. The sealing portion 22 attached with the lamp base 55 is adhered to the reflecting mirror 180, for example, with an inorganic adhesive (e.g., cement) so that they are integrated. A lead wire 185 is electrically connected to the external lead 26 of the sealing portion 22 positioned on the front opening side of the reflecting mirror 180. The lead wire 185 extends from the external lead 26 to the outside of the reflecting mirror 180 through an opening 182 for a lead wire of the reflecting mirror 180. For example, a front glass can be attached to the front opening of the reflecting mirror 180.

Such a lamp unit can be attached to an image projection apparatus such as a projector employing liquid crystal or DMD, and is used as the light source for the image projection apparatus. The discharge lamp and the lamp unit of the above embodiments can be used, not only as the light source for image projection apparatuses, but also as a light source for general illumination or ultraviolet steppers, or a light source for an athletic meeting stadium, a light source for headlights of automobiles or the like.

In Embodiment 3, the lamp enclosing mercury in an amount of 150 mg/cc has been described as an example. However, the amount is not limited thereto, and can be larger or smaller. In other words, in Embodiment 3, the case where the mercury vapor pressure is about 20 MPa (the case of so-called ultra high pressure mercury lamp) has been described. However, the present invention can apply to a high pressure mercury lamp in which a mercury vapor pressure is about 1 MPa. Furthermore, the gap (arc length) between the pair of electrodes 12 can be short, or can be longer than that. The high pressure discharge lamps of Embodiment 3 can be used by either lighting method, alternating current lighting or direct current lighting.

Furthermore, instead of mercury or with mercury, a metal halide can be enclosed. More specifically, in Embodiment 3, a mercury lamp employing mercury as a luminous material has been described as an example of a high pressure discharge lamp. However, the present invention can apply to a high pressure discharge lamp such as a metal halide lamp in which a metal halide is enclosed. However, in the configuration of the discharge lamp of Embodiment 3, it is preferable that the amount of enclosed mercury is about 200 mg/cc or less. This is preferable because with an amount of enclosed mercury of more than that, the pressure in the luminous bulb 10 is too high during operation, so that airtightness cannot be maintained in a portion of the molybdenum foil 24 of the sealing portion 22 and it is highly possible that the lamp is damaged. If it is ensured that the airtightness can be maintained, the amount of enclosed mercury can be larger than 200 mg/cc. When the amount of enclosed mercury exceeds 200 mg/cc, the thermal conductivity of the gas in the luminous bulb 10 becomes high. Therefore, the heat of discharge plasma easily propagates to the electrodes 12 or the luminous bulb 10 (quartz glass), which further raises the temperature, so that impurities more significantly leak from the glass or the electrodes. Therefore, in the case where mercury is enclosed in an amount of more than 200 mg/cc, the advantage of the lamp 1000 of Embodiment 3 produced with a glass tube made of a material having a high purity that has been cleaned satisfactorily is highly distinguished.

Furthermore, in Embodiment 3, the case where the bulb wall load is about 80 W/cm² has been described as an example, but the bulb wall load is not limited thereto. The bulb wall load can be smaller or larger than that. In the case of a higher load, a lamp is operated in a high temperature, and therefore impurities significantly leak from the glass or electrodes. Therefore, the advantage of the lamp 1000 of Embodiment 3 produced with a glass tube made of a material having a high purity is highly distinguished. However, in the configuration of the discharge lamp of Embodiment 3, it is preferable that the bulb wall load is about 100 W/cm² or less. This is preferable because with a load of more than that, the temperature of the luminous bulb 10 is too high, so that deformation or deterioration due to heat may occur. In this case, if these problems can be avoided by adding another means for cooling the luminous bulb 10, the bulb wall load can be larger than 100 W/cm².

Furthermore, in Embodiment 3, the case where the rated power is 150 W has been described as an example, but the rated power is not limited thereto, and can be more than 150 W or less than 150 W. However, the configuration of the discharge lamp of Embodiment 3 is particularly suitable for a lamp having a comparatively large power of 50 W or more. Since a lamp having a large power is operated in a higher temperature, impurities significantly leak from the glass or the electrodes. Therefore, the advantage of the lamp 1000 of Embodiment 3 made of a material having a high purity is highly distinguished. As the discharge lamp of Embodiment 3, a lamp enclosing bromine (Br) as halogen has been described as an example, but halogen can be replaced by chlorine (Cl) or iodine (I).

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A method for cleaning a translucent tube for a discharge lamp having a luminous bulb portion, comprising the steps of:
introducing a cleaning fluid from one end of the translucent tube; and
allowing the cleaning fluid to flow while bringing the cleaning fluid in contact with at least an inner face of the luminous bulb portion of an inner face of the translucent tube, thereby removing impurities attached on the inner face of the luminous bulb portion.

2. The method for cleaning a translucent tube for a discharge lamp of claim 1, wherein in the step of removing impurities, the cleaning fluid is allowed to flow while being in contact with an outer face of the translucent tube in the same step, thereby removing impurities attached on the outer face of the translucent tube.

3. The method for cleaning a translucent tube for a discharge lamp of claim 1, wherein the step of introducing a cleaning fluid includes the steps of:
disposing the translucent tube in a container for containing a cleaning liquid as the cleaning fluid such that ends of the tube are positioned in a substantially vertical direction; and
injecting the cleaning liquid into the container, and
the step of removing impurities includes the steps of:
elevating a liquid surface of the cleaning liquid above an upper portion of the luminous bulb portion of the translucent tube for a discharge lamp; and
lowering the liquid surface of the cleaning liquid below a lower portion of the luminous tube portion.

4. The method for cleaning a translucent tube for a discharge lamp of claim 3, wherein the step of elevating the liquid surface of the cleaning liquid and the step of lowering the liquid surface of the cleaning liquid are repeated.

5. The method for cleaning a translucent tube for a discharge lamp of claim 3, wherein the step of lowering the liquid surface of the cleaning liquid is performed such that the liquid surface of the cleaning liquid is lowered below a lower end of the translucent tube.

6. The method for cleaning a translucent tube for a discharge lamp of claim 3, wherein the step of elevating the liquid surface of the cleaning liquid is performed such that the liquid surface of the cleaning liquid is elevated above an upper end of the translucent tube.

7. The method for cleaning a translucent tube for a discharge lamp of claim 3, further comprising the step of discharging the cleaning liquid in the container from the container.

8. The method for cleaning a translucent tube for a discharge lamp of claim 3, wherein an ending point of cleaning is determined by monitoring a concentration of the impurities contained in the cleaning liquid in the container.

9. The method for cleaning a translucent tube for a discharge lamp of claim 3, wherein the translucent tube is disposed using a holding tool for holding a plurality of translucent tubes such that ends of the tubes are positioned in a substantially vertical direction.

10. The method for cleaning a translucent tube for a discharge lamp of claim 3, wherein the cleaning liquid is one selected from the group consisting of ultrapure water, pure water, deionized water, hydrofluoric acid aqueous solution and hydrogen peroxide aqueous solution, and a combination of one of these cleaning liquids and cleaning fine particles.

11. The method for cleaning a translucent tube for a discharge lamp of claim 3, wherein a plurality of kinds of impurities are attached on the inner face of the luminous bulb portion as the impurities, the method comprising at least:
a first step of introducing a first cleaning liquid as the cleaning liquid from the one end of the translucent tube with respect to a first kind of impurities of the plurality of kinds of impurities, and
a second step of introducing a second cleaning liquid other than the first cleaning liquid as the cleaning liquid from the one end of the translucent tube with respect to a second kind of impurities other than the first kind of impurities of the plurality of kinds of impurities.

12. The method for cleaning a translucent tube for a discharge lamp of claim 1, wherein the cleaning fluid is either one of gas, liquid, or fine particle powder, and
the step of removing impurities attached on the inner face of the luminous bulb portion is performed by discharging the cleaning fluid introduced from one end of the translucent tube for a discharge lamp from the other end of the translucent tube for a discharge lamp.

13. The method for cleaning a translucent tube for a discharge lamp of claim 12, wherein the cleaning fluid is inert gas.

14. An apparatus for cleaning a translucent tube for a discharge lamp comprising:
a container for accommodating a translucent tube for a discharge lamp having a luminous bulb portion and for containing a cleaning liquid;
an injection pipe or an injection tube through which the cleaning liquid is injected into the container;
a discharge pipe or a discharge tube through which the cleaning liquid in the container is discharged; and
a concentration monitoring meter for monitoring a concentration of impurities that was attached on the translucent tube and is contained in the cleaning liquid in the container.

15. The apparatus for cleaning a translucent tube for a discharge lamp of claim 14, wherein the concentration monitoring meter has a function to determine an end of cleaning by comparing an electrical conductivity of the cleaning liquid in the container or the cleaning liquid discharged from the container with a reference value, an electrical conductivity of the cleaning liquid injected to the injection pipe or the injection tube being used as the reference value.

16. The apparatus for cleaning a translucent tube for a discharge lamp of claim 14, wherein the container has an airtight structure that prevents the cleaning liquid in the container from being in contact with air outside the container.

17. A discharge lamp comprising a luminous bulb and sealing portions extending from the luminous bulb, the luminous bulb enclosing a luminous material and including a pair of electrodes opposed to each other therein,
wherein the discharge lamp is produced by a method for producing a discharge lamp comprising the steps of:
preparing a translucent tube for a discharge lamp including a luminous bulb portion that becomes a luminous bulb of the discharge lamp, and side tube portions extending from the luminous bulb portion, the translucent tube having been subjected to a cleaning process;
inserting an electrode assembly including metal foils and electrodes connected to the metal foils into the side tube portion such that heads of the electrodes are positioned inside the luminous bulb portion; and
forming the sealing portions by tightly attaching the metal foils of the electrode assembly to the side tube portions,
the cleaning process comprising the steps of:
(a) introducing a cleaning fluid from one end of a translucent tube for a discharge lamp including a luminous bulb portion that becomes a luminous bulb of the discharge lamp, and side tube portions extending from the luminous bulb portion; and
(b) allowing the cleaning fluid to flow while bringing the cleaning fluid in contact with at least the inner face of the luminous bulb portion of the inner face of the translucent tube, thereby removing impurities attached on the inner face of the luminous bulb portion,
wherein the step (a) includes a step (a-1) of disposing the translucent tube in a container for containing a cleaning liquid as the cleaning fluid such that ends of the translucent tube are positioned in a substantially vertical direction; and a step (a-2) of injecting the cleaning liquid into the container, and
the step (b) includes a step (b-1) of elevating a liquid surface of the cleaning liquid above an upper portion of the luminous bulb portion of the translucent tube; and a step (b-2) of lowering the liquid surface of the cleaning liquid below a lower portion of the luminous tube portion.

18. The discharge lamp of claim 17, wherein
at least mercury as the luminous material, a rare gas and halogen are enclosed in the luminous bulb, and the luminous bulb is made substantially of quartz glass, and the electrodes are made substantially of tungsten, and
a mole number of the halogen is larger than a sum of a total mole number of metal elements that have a property of bonding to the halogen and are present in the luminous bulb (except for tungsten and mercury), and a mole number of the tungsten present in the luminous bulb after evaporated from the electrodes during lamp operation.

19. The discharge lamp of claim 18, wherein
the mole number of the halogen enclosed in the luminous bulb is not less than five times the total mole number of sodium (Na), potassium (K), lithium (Li), chromium (Cr), iron (Fe) and nickel (Ni) present in the luminous bulb.

20. The discharge lamp of claim 17, wherein
the discharge lamp is a mercury lamp in which a bulb wall load of the luminous bulb is 80 W/cm² or more.
